(19) United States
(12) Patent Application Publication
(10) Pub. No.: US 2008/0059293 A1
(43) Pub. Date: Mar. 6, 2008

(54) ADVERTISING PLACEMENT SYSTEM AND METHOD

(76) Inventor: Charles Hengel, Woodland, MN (US)

Correspondence Address: SCHWEGMAN, LUNDBERG & WOESSNER, P.A., P.O. BOX 2938, MINNEAPOLIS, MN, 55402, US

(21) Appl. No.: 11/469,743

(22) Filed: Sep. 1, 2006

(51) Int. Cl. G06Q 30/00

(52) U.S. Cl. 705/14

(57) ABSTRACT

This document describes, among other things, systems and methods for placing advertisements. A method comprises an advertiser entering at least one offer to place a live-read radio advertisement into an advertisement placement system, wherein the advertiser indicates at least one amount it is willing to pay for the live-read radio advertisement; at least one media station accessing the placement system to view the at least one offer; the at least one media stations using the placement system to accept the least one offer; following acceptance of the at least one offer by at least one of media stations, precluding the at least one offer from being accepted by a different media station; and the media station that accepted the offer performing a live-read of the at least one advertisement associated with the accepted offer.

### TECHNICAL FIELD

This patent document pertains generally to buying and selling advertisements, and more particularly, but not by way of limitation, to an advertisement placement system and method.

### BACKGROUND

Media stations, such as radio stations and television stations, typically devote a portion of broadcast time to advertisements. This advertisement broadcast time is sold to advertisers, frequently, through advertising agencies, and the sold broadcast time generates revenue for the media station.

Advertising demand is primarily driven by advertisers who selectively purchase broadcast time based on a particular demographic or a particular geographic region. In large markets, advertisers are burdened with evaluating many media stations in a quest to reduce advertising costs while meeting marketing demands. Similarly, media stations are burdened by having to negotiate with many advertisers in an effort to maximize revenue.

Because of the large number of advertisers vying for advertising broadcast time and because of the limited premium time available, advertisers may be forced to purchase advertising time days or weeks in advance. Advertisements may be written, produced, and purchased weeks in advance of broadcast. Thus, broadcasted advertisement content may have a reduced return on investment value because it is no longer current.

An advertiser that has an immediate need to broadcast an advertising message on multiple radio stations may not be able to do so when stations plan their advertising a week or more in advance. Event driven and other forms of advertising often result in the need to place and air advertising within a few minutes after deciding to advertise. However, media stations cannot accommodate such on-the-spot advertising on a large scale.

In addition, media stations have a difficult time maximizing the value of their limited advertising space at the last minute, which often results in this space being given away at no charge. They also lack methods to increase revenue outside of the traditional media planning process

### BRIEF DESCRIPTION OF THE DRAWINGS

FIG. 1 is a block diagram of an advertisement placement system in accordance with an example embodiment.

FIG. 2 is a chart illustrating a media station table according to an example embodiment.

FIG. 3 is a chart illustrating an advertising campaign table according to an example embodiment.

FIG. 4 is a chart illustrating a placement results table according to an example embodiment.

FIG. 5 is a flow diagram of a method of placing advertisements in accordance with an example embodiment.

FIG. 6 is a flow diagram of a method of placing advertisements in accordance with an example embodiment.

FIG. 7 illustrates a diagrammatic representation of a machine capable of performing the methods or implementing the systems/devices described herein.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

Described herein is a system and a method that provides an interface between advertisers and media stations (e.g., radio and television stations). In an embodiment, the interface facilitates a wide area network-based buying and selling model and further allows an advertiser to modify advertisement content at or near real-time. For the purposes of this description, radio and radio transmissions include terrestrial or satellite audio transmissions.

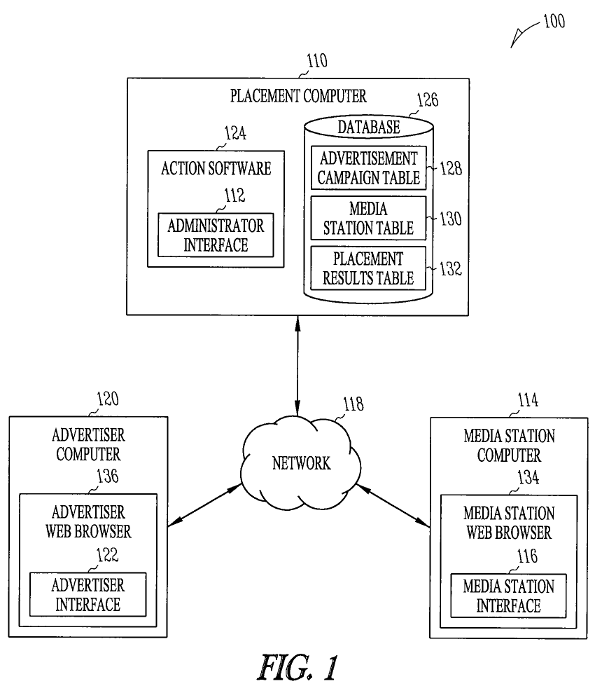

Referring to the figures, FIG. 1 is a block diagram of an advertisement placement system 100 in accordance with an example embodiment. In an embodiment, advertising placement system 100 includes a placement computer 110. Placement computer 110 may include, in embodiments, placement software 124, an administrator interface 112, and a database 126.

In some embodiments, placement software 124 includes markup language documents (e.g., HTML), script files (e.g., JavaScript, Active Server Pages, CGI, Perl), library files (e.g., DLL), or executable files (e.g., EXE). In a further embodiment, placement software 124 includes database and network interfaces, such as to connect to database 126 or network 118. Placement software 124 may, in some embodiments, be served within a web server environment. In alternative embodiments, placement software 124 includes a proprietary server application and requires proprietary client applications to enable the placement system 100.

Placement computer administrator interface 112 may be provided by placement software 124 using one or more of the technologies described above. In particular, in an embodiment, administrator interface 112 is provided to a user (e.g., administrator) in a web browser (e.g., Microsoft Internet Explorer). The administrator interface 112 may include a combination of static and dynamic elements as described in more detail below. An administrator may use administrator interface 112 to determine or manage availability, security, and access of placement computer 110.

Database 126 includes advertisement campaign table 128, media station table 130, and placement results table 132, in embodiments. Database 126 may be implemented as a relational database, a central database, a distributed database, an object database, or a flat file database, in various embodiments.

Advertisement campaign table 128 includes one or more data fields describing aspects of an advertisement or an advertisement campaign. For example, advertisement campaign table 128 may include an advertiser name or identification, a product, an advertisement content, a target demographic, a market geography, a maximum bid, a total budget, a budget spent, and the like.

Media station table 130 includes one or more data fields describing aspects of a media station. For example, media station table 130 may include a media station identifier, a media station name, one or more geographies, one or more demographic indications, and the like.

Placement results table 132 includes placement results data, derived from placement software 124. In an embodiment, placement results table 132 is periodically or regularly updated by placement software 124.

In addition, advertisement placement system 100 may include one or more media station computers 114 (e.g., clients). In an embodiment, each media station computer 114 includes a media station web browser 134, which may connect to the placement computer 110 via network 118. Media station web browser 134 can be used to provide media station interface 116. Media station interface 116 may be used by users (e.g., a media station advertising administrator) to provide details about a media station, such as demographic profile and advertising costs.

Network 118 may include, in various embodiments, wired or wireless network connections. In addition, network 118 may be implemented as a local area network (LAN), wide area network (WAN), or a combination. In an example embodiment, network 118 includes the Internet.

In addition, advertisement placement system 100 may include one or more advertiser computers 120. Similar to users of a media station computer 114, users of an advertiser computer 120 may use a web browser (e.g., advertiser web browser 136) to access placement computer 110 via network 118. Advertiser interface 122 is provided by placement software 124 and presented using advertiser web browser 136.

In operation in an example embodiment, a media station user can use media station computer 114 and connect to placement computer 110 via network 118. If the media station user had not previously connected with placement computer 110, then in one embodiment, the media station user may have to create an account. Using media station interface 116, the media station user can provide media station characteristics (e.g., demographics or geography of the listening audience) and, in one example embodiment, a minimum amount the media station will accept to air an advertisement.

An advertising user may connect to placement computer 110 using advertiser computer 120 via network 118. In an embodiment, if the advertising user has not used the system 100 before to place advertising, then the advertising user may have to create an account on placement computer 110. The advertising user can submit one or more advertising campaigns to placement computer 110 via placement software 124. Advertising campaigns include details about a product's advertising, such as the product, advertisement content, and advertising budget. In an embodiment, the advertising user may update or revise one or more of the parameters provided after submitting the advertising campaign. For example, the advertising user may adjust the maximum bid. As another example, the advertising user may revise advertising content in or near real-time, such that the next time the advertisement is read or displayed, the revised content is used.

As an advertising placement request runs, placement software 124 periodically, regularly or from time to time analyzes media station table 130 and advertising campaign table 128 to determine if one or more advertisements contained in advertising campaign table 128 correspond to or match available markets, as described in media station table 130. In one example embodiment, every characteristic of a media station (e.g., demographic coverage, geographic coverage, minimum bid amount) must match a corresponding advertising campaign characteristic, as stored in the advertising campaign table 128, to be included in the placement results table 132. In an alternative embodiment, one or more media station characteristics may not match, but may be close enough to include in placement results table 132. Thresholds to control close matches may be provided by media stations or advertisers. Additionally, placement software 124 may receive and manage bids from other advertisers or receive and manage media station advertisement opportunities from other media stations. Placement results derived from at least placement results table 132 are provided to media station computer 114 and advertiser computer 120 via media station interface 116 and advertiser interface 122 respectively. In an embodiment, a user (e.g., a media station user such as a DJ), can interact with media station interface 116 to update the placement results displayed on media station interface 116. In an embodiment, placement results are provided using a “push” system, such that a media station computer 114 is automatically or regularly refreshed with updated content from the placement computer 110. Placement results may be refreshed when an event is detected. Events may include an update to an advertising campaign, such as when an advertisement campaign is added or removed from the advertising campaign table 128, or when an advertising campaign is updated, such as when a media station broadcasts an advertisement and an advertising campaign's budget is updated, which may affect its availability to other media stations. Another event may be an update of an advertising campaign by the advertising user. Updates may include changing the maximum bid, changing the target demographic or geography, or modifying the advertising content.

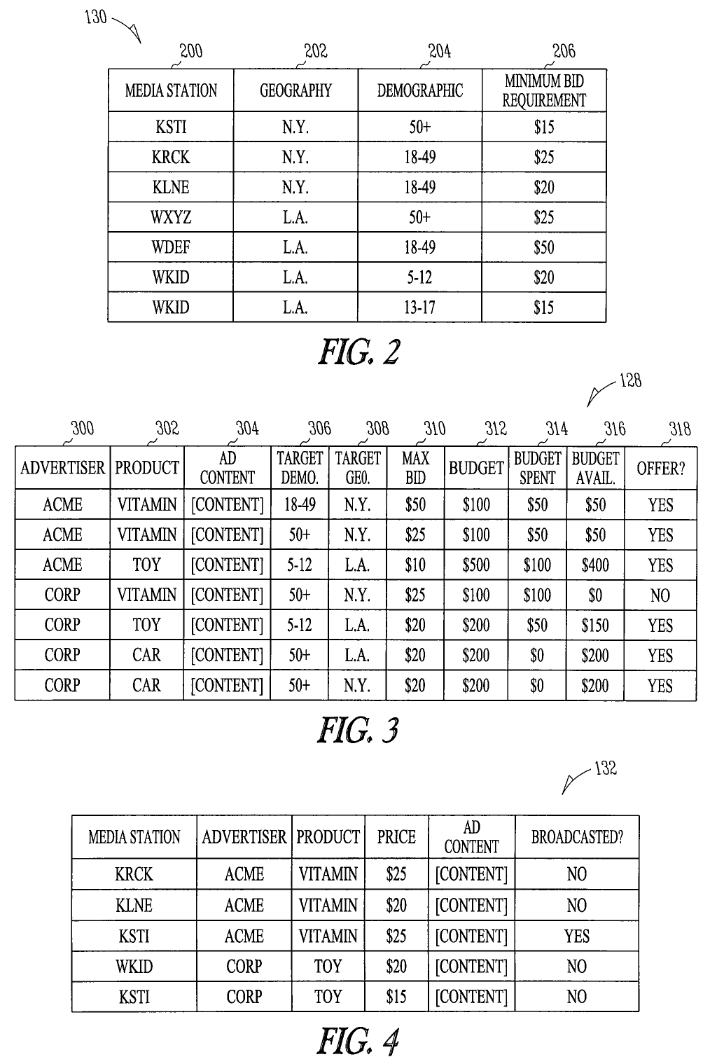

FIG. 2 is a chart illustrating a media station table 130 according to an example embodiment. Media station table 130 includes a media station ID field 200, geography field 202, demographic field 204, and minimum bid requirement field 206. Geography field 202 may be include segmentation by city, state, region (e.g., metro area, Southern Minnesota), or other definable geographic regions. Demographic field 204 may include listener or viewer age range, income levels, number of listeners or viewers, or other demographic indicators. Minimum bid requirement field 206 represents the minimum amount a media station would accept to run an advertisement. In an embodiment, the minimum bid requirement field 206 indicates the minimum cost per thousand (CPM) impressions or uses. The minimum bid requirement field 206 may be adjusted by a user of media station computer 114 in response to market conditions, a media station's preferences, or other factors. In an embodiment, minimum bid requirement field 206 may be adjusted programmatically. For example, a user may define one or more minimum bids as a function of time, such as time of day, day of week, season, or the like, and the placement software 124 can automatically adjust the minimum bid requirement field 206 accordingly. In another embodiment, media stations that serve multiple geographic regions or demographic audiences may have distinct records, e.g., two or more rows in media station table 130) which correspond to the distinct regions or audiences. In such an embodiment, the corresponding minimum bid requirement may differ as a function of the region or audience served.

FIG. 3 is a chart illustrating advertising campaign table 128 according to an example embodiment. Advertising campaign table 128 includes an advertiser field 300, product field 302, ad content field 304, target demographic field 306, target geography field 308, maximum bid field 310, budget field 312, budget spent field 314, budget available field 316, and offer? field 318. Ad content field 304 may contain the actual advertising content, such as a textual script or description of the product, or may contain a link to the advertising content. Target demographic field 306 may include one or more indications of a target demographic group, such as by income, age, or the like. Target geography field 308 may include segmentation by city, state, region (e.g., metro area, Southern Minnesota), or other definable geographic regions. The maximum bid field 310 indicates the maximum an advertiser is willing to spend for an advertisement to run (e.g., be played or read). The budget field 312 is an indication of the budget allotted for the particular advertising campaign. The offer? field 318 indicates whether the advertising campaign bid is active.

FIG. 4 is a chart illustrating a placement results table 132 according to an example embodiment. In the embodiment depicted, every characteristic of a media station must match corresponding characteristics of an advertising campaign for the bid to be accepted by the placement software 124 and stored in the placement results table 132. For example, referring to FIG. 2, the media station “KRCK” has a geography of “N.Y.,” a demographic audience of “18-49,” and a minimum bid requirement of “$25.” After analyzing the advertising campaign table 128, as illustrated in FIG. 3, the placement software 124 can determine that the only advertising campaign with an exact match is ACME's vitamin product, which has a target demographic of “18-49,” a target geography of “N.Y.,” a maximum bid of “$50,” that exceeds the media station's minimum bid of “$25.” Thus, for media station KRCK, ACME's vitamin product would be available, such as displayed on media station interface 116 in media station web browser 134. When two or more advertisers match a particular media station's characteristics, then the advertiser with the higher maximum bid is stored in the placement results table 132 with the price of the higher maximum bid.

FIG. 5 is a flow diagram of a method 500 of placing advertisements in accordance with an example embodiment. At 502, one or more advertisements or advertisement campaigns are received. In an embodiment, the advertisements are provided by advertisers using advertiser computer 120 and advertiser interface 122 as described in FIG. 1. In a further embodiment, advertisements are stored in advertising campaign table 128. Some or all of the information stored in advertising campaign table 128 may be marked as read-only after the advertiser submits the information. In another embodiment, all of the information in the advertisement campaign table 128 may be edited or removed by the advertiser. Advertising budgets may be related to a particular product such that a budget is shared across several demographic or geographic spaces, or the budget may be particular to a specific demographic or geographic space. For example, a budget may be associated with “Product A” as marketed in “New York” and “Los Angeles” markets. In an alternative example, one budget may be associated with “Product A” as marketed in “New York” while a separate budget may be associated with “Product A” as marketed in “Los Angeles.” Adjusting any remaining budget available may then depend on which market was served the advertisement.

At 504, one or more media station parameters are received. In an embodiment, the media station parameters are provided by media stations and include data that identifies the media station, describes the media station's audience (e.g., demographic information or geographic information), or placement-related information, such as a minimum bid amount. Additional information may include such things as product preferences, estimated audience size, or other metrics useful in matching an advertiser to a target market. In an embodiment, a media station may include one or more parameters that cause advertising to be automatically selected. For example, in some placement models, a “buy out” price is indicated such that if a purchaser wants to immediately finalize a purchase, the purchaser may indicate that they are willing to pay the “buy out” price and then will be automatically awarded the offered item. In this context, a media station may provide a threshold price, such that if any advertiser has a maximum bid amount greater than or equal to the threshold price, the advertisement is automatically selected and stored in the placement results table 132.

At 506, advertisement parameters and media station parameters are analyzed. In an embodiment, the analysis attempts to match an advertisement campaign with at least one media station using at least one of a demographic indication or a geographic indication. In an embodiment, a match is found only when all demographic or geographic constraints provided by an advertiser in advertising campaign table 128 match the demographic or geographic profile of a media station. In another embodiment, at least one demographic or geographic constraint contained in the advertising campaign table 128 has to match a demographic or geographic indicia of a media station. In an embodiment, matches that fail to correspond at each demographic or geographic factor may be rated, such as by a score (e.g., 7/10 or 4 stars) and the score may be provided to the media station computer 114 or the advertiser computer 120. At 508, any matches are stored, such as in the placement results table 132.

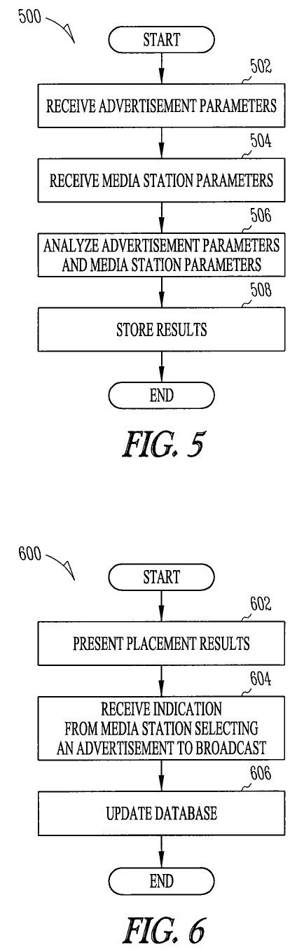

FIG. 6 is a flow diagram of a method 600 of placing advertisements in accordance with an example embodiment. At 602, placement results are presented. In an embodiment, placement results are only available to the media station user via the media station interface 116. Results may be filtered by the viewing media station and the media station user may use the results to determine which advertisement to use during an advertising broadcast. In an alternative embodiment, some or all of the advertising results are made available to the advertiser user at the advertiser computer 120. Advertiser users may be interested in knowing advertising costs or trends in the placement-based format. In such an embodiment, the identity of winning advertisers may be suppressed to maintain privacy.

At 604, an indication is received selecting an advertisement campaign (e.g., an advertisement) that will be broadcasted. For example, a media station user using media station interface 116 may activate an icon, link, or other graphical user interface control to select an advertisement from placement results presented on media station interface 116. In the context of a radio station, a radio announcer may select a matching advertisement from the placement results display and read the corresponding advertisement text during a broadcast (e.g., ad content field 304 in advertisement campaign table 128 in FIG. 3).

In some embodiments, a media station user may select one or more advertisements to reserve them for later broadcast. This mechanism may be preferable in a live broadcast where the announcer (e.g., disc jockey) may prepare advertisements a few moments before the advertisement is read. For example, while music is playing, a DJ may use that time to select one or more advertisements for live broadcast and to plan a segue into the next advertising program break. In such an embodiment, the advertisement campaign budget may be debited by the amount of the advertising cost or have some other indication that the advertisement campaign has a reserved selected advertisement queued for broadcast. If the media station user fails to actually use the advertisement, then a fee may be charged to the media station for reserving the advertisement inappropriately. The fee may be a function of the price of the advertisement, such as a percentage. Alternatively, the media station may be restricted from reserving further advertising if a threshold number of unmet commitments are detected. For example, a media station user may be restricted from reserving advertising if the number of advertisements read is less than 85% of the number of advertisements reserved or selected. This type of mechanism may dissuade a media station user from blocking other media stations from access to the advertisement for prolong periods without actually using the advertising.

In an embodiment, where multiple advertisers meet the media station's characteristics and minimum bid requirement, two or more qualifying advertisements are displayed to the media station user. In such a case, the media station user may choose to advertise a particular advertisement based on some other preference other than the maximum bid amount offered.

In an embodiment, advertisers can update their advertisement content in or near real-time by using the advertiser interface 122 to access the advertisement campaign table 128, such that the media station will broadcast the most current version. To ensure currency, in an embodiment, each time the advertising campaign is selected by a media station user to be advertised, the advertisement campaign table 128 is accessed by placement software 124 and the most current version of the ad is retrieved from the ad content field 304. Advertising content may be generated from various sources. For example, an advertiser may want to update advertising content to reflect one or more frequently used search terms found on the Internet.

Using such a system may be advantageous to provide an advertiser with a way to maintain updated and current advertising content and for a media station to be provided with advertisements that match one or more of the media station's characteristics. Such a system also allows for media stations who read an advertisement content over a live broadcast to be assured of relaying the most current information for their audience.

At 606, the database is updated to reflect the transaction. For example, after the advertisement is broadcasted, the advertiser is charged for the broadcast. The charge may be reflected in the advertising campaign table 128, such as in budget spent field 314. Additionally, placement results table 132 may be updated to reflect that the advertising campaign was broadcast and may further include details such as time and date of the broadcast. In an embodiment, the database update initiates re-analysis of the advertisement parameters and media station parameters (step 506 in FIG. 5) to revise or update the placement results table 132, for example, to recalculate matches based on updated budgets.

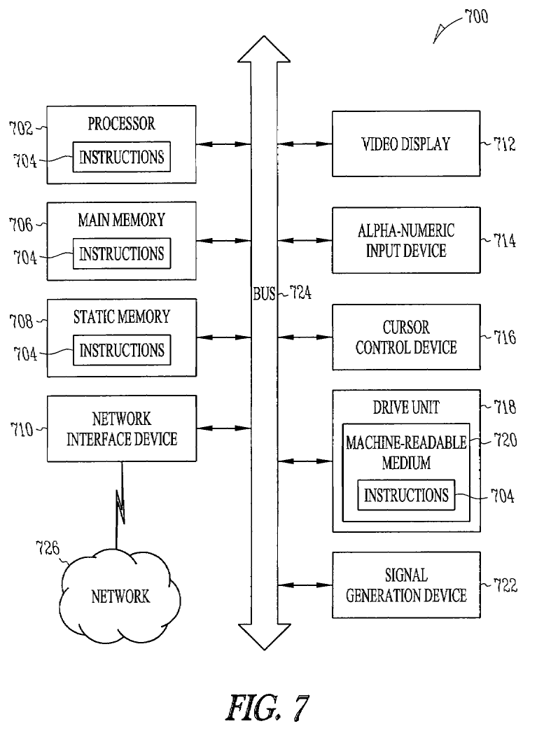

FIG. 7 illustrates a diagrammatic representation of a machine 700 capable of performing the methods or implementing the systems/devices described herein. In alternative embodiments, the machine may comprise a computer, a network router, a network switch, a network bridge, a Personal Digital Assistant (PDA), a cellular telephone, a web appliance, a set-top box (STB) or any machine capable of executing a sequence of instructions that specify actions to be taken by that machine.

The machine 700 includes a processor 702, a main memory 706, and a static memory 708, which communicate with each other via a bus 724. The machine 700 may further include a video display unit 712 (e.g., a liquid crystal display (LCD) or a cathode ray tube (CRT)). The machine 700 also includes an alphanumeric input device 714 (e.g., a keyboard), a cursor control device 716 (e.g., a mouse), a disk drive unit 718, a signal generation device 722 (e.g., a speaker) and a network interface device 710 to interface the computer system to a network 726.

The disk drive unit 718 includes a machine-readable medium 720 on which is stored a set of instructions or software 704 embodying any one, or all, of the methodologies described herein. The software 704 is also shown to reside, completely or at least partially, within the main memory 706 and/or within the processor 702. The software 704 may further be transmitted or received via the network interface device 710.

For the purposes of this specification, the term “machine-readable medium” shall be taken to include any medium which is capable of storing or encoding a sequence of instructions for execution by the machine and that cause the machine to perform any one of the methodologies of the inventive subject matter. The term “machine-readable medium” shall accordingly be taken to include, but not be limited to, solid-state memories, optical and magnetic disks, and carrier wave signals. Further, while the software is shown in FIG. 7 to reside within a single device, it will be appreciated that the software could be distributed across multiple machines or storage media, which may include the machine-readable medium.

Although specific embodiments have been illustrated and described herein, it will be appreciated by those of ordinary skill in the art that any arrangement that achieves the same purpose, structure, or function may be substituted for the specific embodiments shown. This application is intended to cover any adaptations or variations of the example embodiments of the invention described herein. It is intended that this invention be limited only by the claims, and the full scope of equivalents thereof.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

1. A method comprising:
an advertiser entering at least one offer to place a live-read radio advertisement into an advertisement placement system, wherein the advertiser indicates at least one amount it is willing to pay for the live-read radio advertisement;
at least one media station accessing the placement system to view the at least one offer;
the at least one media station using the placement system to accept the at least one offer;
following acceptance of the at least one offer by at least one media station, precluding the at least one offer from being accepted by a different media station; and
the media station that accepted the offer performing a live-read of the at least one advertisement associated with the accepted offer.

2. The method according to claim 1 further wherein the at least one amount is the maximum amount the advertiser is willing to pay for the live-read radio advertisement.

3. The method according to claim 2 further wherein the at least one media station enters into the placement system at least one price at which they are willing to perform a live-read radio advertisement, and the placement system uses the at least one price to determine which of the at least one media stations to present the at least one offer to.

4. The method according to claim 1 further wherein the offer to place a live-read radio advertisement is offered to at least two media stations.

5. The method according to claim 1 further including the advertiser entering into the placement system one or more characteristics specifying a desired audience for the radio advertisement.

6. The method according to claim 1 further including the placement system matching the one or more characteristics to at least one media station.

7. A method comprising:
at least one person associated with a radio station viewing one or more transitory offers to place a live-read radio advertisement;
the at least one person associated with the radio station accepting at least one of the offers; and
reading live on a radio broadcast from the radio station an advertisement associated with the accepted offer substantially simultaneously with the acceptance of the offer.

8. A method comprising:
accessing one or more advertisement campaign parameters that describe at least a target market and a maximum advertising bid for an advertisement campaign;
accessing one or more media station parameters that describe at least a media station's audience and a minimum acceptable bid for a media station; and
matching the advertisement campaign to one or more media stations using the advertisement campaign parameters and the media station parameters.

9. The method according to claim 8, wherein the advertisement campaign parameters include an advertiser, a product description, an ad content, one or more target demographic indications, one or more target geographic indications, a maximum bid amount, or a budget.

10. The method according to claim 8, wherein the media station parameters include a media station identification, one or more demographic indications, a geographic indication, or a minimum bid amount.

11. The method according to claim 8, further comprising:
presenting advertisers that match a media station to a media station user associated with the media station;
receiving an indication from the media station user, the indication selecting an advertisement to broadcast; and
updating a database to record the transaction.

12. The method according to claim 11, further comprising:
accessing the advertisement to broadcast to obtain a current version of the advertisement; and
providing the current version of the advertisement to the media station user for broadcast.

13. The method according to claim 12, wherein the broadcasting includes the media station user reading the advertisement live over a radio broadcast.

14. A method comprising:
accessing one or more advertisement parameters which include an advertiser, a product description, an ad content, one or more target demographic indications, one or more target geographic indications, a maximum bid amount, or a budget;
accessing one or more media station parameters which include a media station identification, one or more demographic indications, a geographic indication, or a minimum bid amount; and
using the advertisement parameters and the media station parameters to determine a match between one or more advertisers and one or more media stations.

15. The method according to claim 14, further comprising storing the matching advertisers and media stations.

16. The method according to claim 14, further comprising:
presenting the matching advertisers to a media station user;
receiving an indication from the media station user, the indication selecting an advertisement to broadcast; and
updating a database to record the transaction.

17. The method according to 16, further comprising:
accessing the advertisement to broadcast to obtain a current version of the advertisement; and
providing the current version of the advertisement to the media station user for broadcast.

18. The method according to 17, wherein the broadcast includes a live-reading of the advertisement.

19. A method comprising:
accessing an advertisement placement system;
providing one or more parameters that characterize a media station or a media station's audience;
receiving an indication of zero or more advertisement opportunities, wherein each advertisement opportunity matches one or more of the provided parameters.

20. The method according to 19, further comprising:
selecting an advertisement from the received advertisement opportunities;
broadcasting the advertisement; and
providing an indication to the advertisement placement system that the advertisement was broadcasted.

21. The method according to 20, wherein broadcasting the advertisement includes reading an advertisement content associated with the selected advertisement.

22. A method comprising:
accessing an advertising placement system;
providing, to the advertising placement system, one or more parameters that describe one or more advertising campaigns; and
receiving, from the advertising system, one or more indicia that provide a status of the provided advertising campaigns.

23. The method according to claim 22, wherein the parameters include an advertiser identification, a product description, an ad content, one or more target demographic indications, one or more target geographic indications, a maximum bid amount, or an advertising budget.

24. The method according to claim 23, further comprising:
accessing the advertising placement system;
revising an ad content using one or more frequently used search terms; and
storing the revised ad content at the advertising placement system to be used during the next broadcast of the advertisement.

25. A system comprising:
a server comprising:
a database configured to store advertisement campaigns, media station information, and placement data; and
a processor configured to:
access the database to obtain advertisement campaign data;
access the database to obtain media station information; and
determine one or more corresponding advertisers and media stations using at least one of a demographic indication or a geographic indication;
a media station computer, communicatively coupled to the server, the media station computer configured to interface with the server and provide one or more media station profiles to the server; and
an advertiser computer, communicatively coupled to the server, the advertiser computer configured to interface with the server and provide one or more advertising campaigns.

26. The system according to claim 25, wherein the media station profile includes a media station identifier, a media station name, one or more geographies, or one or more demographic indications.

27. The system according to claim 25, wherein the advertising campaign includes an advertiser, a product description, an ad content, one or more target demographic indications, one or more target geographic indications, a maximum bid, or a budget.
